(19) United States
(12) Patent Application Publication
(10) Pub. No.: US 2007/0159936 A1
(43) Pub. Date: Jul. 12, 2007

(54) Optical head unit and optical disc apparatus

(76) Inventors: Katsuo Iwata, Yokohama-shi (JP); Kazuhiro Nagata, Yokohama-shi (JP); Hideaki Okano, Yokohama-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/646,950

(22) Filed: Dec. 28, 2006

(30) Foreign Application Priority Data
Dec. 28, 2005 (JP) 2005-378118

(51) Int. Cl. G11B 7/00

(52) U.S. Cl. 369/44.23; 369/112.02; 369/44.32

(57) ABSTRACT

According to one embodiment, an optical head unit according to an embodiment of the invention, a reflected beam guided to a detection area of a photodetector is changed in the image forming characteristic by a liquid crystal element, which is placed between an object lens and a collimator lens, and provided with a controllable diffraction index, according to a spherical aberration amount corresponding to a thickness error in a protection layer of an optical disc and a comatic aberration amount corresponding to a disc tilt of an optical disc.

### CROSS-REFERENCE TO RELATED APPLICATIONS

This application is based upon and claims the benefit of priority from Japanese Patent Application No. 2005-378118, filed Dec. 28, 2005, the entire contents of which are incorporated herein by reference.

### BACKGROUND

1. Field

One embodiment of the invention relates to an optical disc apparatus which records or reproduces information in/from an optical disc or an optical information recording medium, and an optical head unit incorporated in the optical disc apparatus.

2. Description of the Related Art

A long time has been passed since the commercialization of an optical disc capable of recording information or reproducing recorded information in a noncontact manner by using a laser beam, and an optical disc apparatus (optical disc drive) capable of recording and reproducing information in/from an optical disc. Optical discs called CD and DVD with several kinds of recording density have become popular.

Recently, an ultra-high density optical disc (High Definition Digital Versatile Disc, hereinafter called HD DVD), which is capable of saving HD-standard video data and high-quality surround audio data in one disc by using a blue or blue-purple laser beam with a short wavelength, has been put to practical use.

In DVD or HD DVD optical disc, particularly HD DVD optical disc, it is known that a record mark itself is very small because of an increased density of a string of record marks, a change in the thickness of a layer to protect a recording layer of a recording medium has a large influence, and reproduction of information becomes unstable.

Japanese Patent Application Publication (KOKAI) No. 2004-178773 reports an optical head unit, which has a liquid crystal element between a light source and a recording medium, and decreases the influence of spherical aberration caused by a change in the thickness of a protection layer to protect a recording layer by operating the liquid crystal when the thickness of the protection layer is changed.

Japanese Patent Application Publication (KOKAI) No. 2000-251303 reports a liquid crystal device, which is formed by stacking two liquid crystal layers having electrodes orthogonal to each other, to correct the influence of a change in the thickness of a protection layer to protect a recording layer of a recording medium by using a liquid crystal element.

Japanese Patent Application Publication (KOKAI) No. 10-79135 reports a tilt servo unit, in which a liquid crystal element is inserted into an optical path, to decrease the influence of comatic aberration caused by a disc tilt occurred during rotation of a recording medium. The unit receives a diffraction light reflected on an optical recording medium, and obtains the amounts of tilt in a radial direction and in a tangential direction.

However, in the Publications No. 2004-178773 and No. 2000-251303 need an independent detection cell and a detection system to guide an optical beam to the detection cell, to detect spherical aberration.

The tilt serve unit described in the Publication No. 10-79135 needs an independent tilt sensor, and a complex liquid crystal driving circuit matching the phase difference characteristic of a liquid crystal panel.

Thus, even if the optical head unit, liquid crystal device and tilt servo unit described in the above applications are used, the size of an optical head unit (pickup unit) is increased, and a signal processing system is complicated.

Moreover, in any optical head unit (pickup unit) described in the above applications, a wavefront of a laser beam is divided and partially used, and the light use efficiency is low, and the gain is small.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are exemplary diagrams showing an example of an optical disc apparatus in accordance with an embodiment of the invention;

FIG. 2 is an exemplary flowchart showing a procedure of detecting comatic aberration (disc tilt) of an optical disc by a liquid crystal element of an optical head of the optical disc apparatus shown in FIG. 1, according to an embodiment of the invention;

FIG. 3 is an exemplary flowchart showing a procedure of detecting comatic aberration (disc tilt) of an optical disc by a liquid crystal element of an optical head of the optical disc apparatus shown in FIG. 1, according to an embodiment of the invention;

FIGS. 4A and 4B are exemplary diagrams showing an example of an optical disc apparatus in accordance with an embodiment of the invention;

FIGS. 5A and 5B are exemplary diagrams, each showing an example of a diffraction (polarization) pattern of a wavefront dividing element used in the optical head unit shown in FIGS. 4A and 4B, according to an embodiment of the invention;

FIG. 5C is an exemplary diagram explaining a combination of outputs received in detection areas of a photodetector, according to an embodiment of the invention; and

FIGS. 6A to 6C are exemplary diagrams, each showing the relationship between an image forming pattern formed in a light-receiving area of a photodetector incorporated in the optical head shown in FIG. 5C, and a change in the thickness of a protection layer of an optical disc, or the degree of disc tilt.

### DETAILED DESCRIPTION

Various embodiments according to the invention will be described hereinafter with reference to the accompanying drawings. In general, according to one embodiment of the invention, an object lens which captures an optical beam reflected on a recording surface of a recording medium;

a phase control member which transmits an optical beam captured by the object lens in a state including the influence of at least one of a spherical aberration that is a change in the thickness of a protection layer to protect a recording surface of a recording medium and a comatic aberration that is an influence of oscillation of a recording surface of a recording medium during rotation, and associates with a change in parallelism of the optical beam according to the degree of a change in the thickness of the protection layer or oscillation of the recording surface during rotation; and

a photodetector which detects an optical beam passing through the phase control member by optional number of detection cells, and obtains an output to set the amount of control of the phase control member.

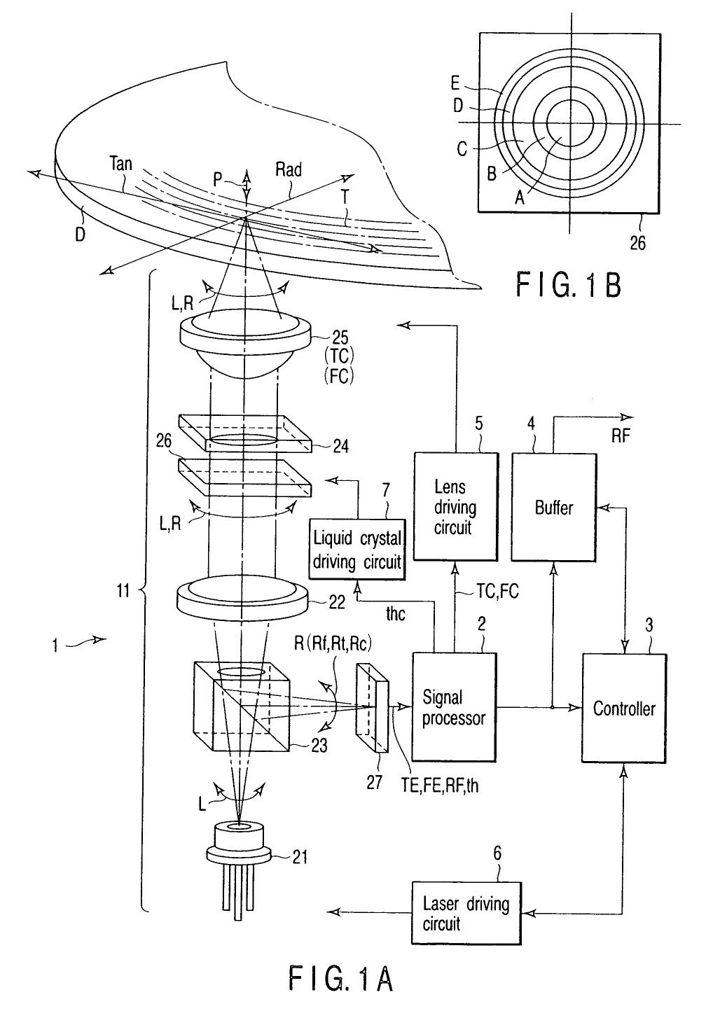

Embodiments of the invention will be explained in detail hereinafter with reference to the accompanying drawings. According to an embodiment, FIG. 1 shows an example of a configuration of an information recording/reproducing apparatus (optical disc apparatus) according to the invention.

An optical disc apparatus 1 shown in FIGS. 1A and 1B includes an optical pickup (optical head unit) 11, which can record information in a not-shown recording layer (organic film, metallic film or phase changing film) of a recording medium (optical disc) D, read information from the recording layer, or erase information recorded in the recording layer. In addition to the optical head unit 11, the optical disc unit 1 has mechanical elements, such as, a not-shown head moving mechanism which moves the optical head unit 11 along a recording surface of the optical disc D, and a disc motor (not shown) which rotates the optical disc D at a predetermined speed. These mechanical elements will not be described in detail. The optical disc unit 1 also includes a signal processor to process the output of a photodetector incorporated in the optical head unit 11, and a controller to control the mechanical elements of the optical head unit 11, as described later.

The optical head unit 11 includes a laser diode (LD) 21 or a semiconductor laser element as a light source. The wavelength of an optical beam emitted from the laser diode (LD) 21 is 400 to 410 nm, preferably 405 nm.

An optical beam from the laser diode 21 is collimated (paralleled) by a collimator lens (CL) 22, given a predetermined convergence by an object lens (OL) 25 as a condensing element, and condensed on the recording layer of the recording surface of the optical disc D. The object lens 25 is made of plastic, and has a numerical aperture NA of 0.65.

The recording layer of the optical disc D has a guide groove, a track or a string of record marks (recorded data) formed concentrically or spirally at a pitch of 0.34 μm-1.6 μm. A string of recorded data (record marks) may be molded as one body by embossing when molding a disc.

The optical beam from the LD 21 is guided to a polarization beam splitter (PBS) 23 before collimated by the collimator lens 22, and a plane of polarization of a wavefront is directed to a specific direction.

The optical beam transmitted through the polarization beam splitter 23 is transmitted to a hologram diffraction element (HOE) 24 as a wavefront dividing element, before applied to the object lens 25. The hologram diffraction element (HOE) 24 is given on its one side a hologram to act only on a reflected beam from the recording layer of the recording surface of the optical disc D, and has the thickness defined to function as a known λ/4 plate. The optical beam, transmitted to the wavefront dividing element 24 and given a predetermined convergence by the object lens 25, is condensed on the recording layer (or a nearby area) of the optical disc D. Namely, the optical beam provides a minimum optical spot at a fixed focal position of the object lens 25.

Between the collimator lens 22 and hologram diffraction element 24, or between the hologram diffraction element 24 and object lens 25 (between the collimator lens 22 and hologram diffraction element 24, in FIGS. 1A and 1B), a liquid crystal element 26 whose thickness or a refractive index can be optionally set to decrease the degree of the influence of uneven thickness of a not-shown protection layer to protect the recording layer of the optical disc D on the intensity of an RF (reproducing signal) explained later.

The object lens 25 (optical head unit 11) is positioned at a predetermined position in the track direction crossing a record mark string or a track T (indicated by the arrow T) of the optical disc D, and at a predetermined position in the focus direction (indicated by the arrow F) or the recording layer thickness direction, by a not-shown object lens driving mechanism including a driving coil and a magnet.

Moving the object lens 25 in the track direction and controlling the position of the object lens 25 to adjust the minimum optical spot of the optical beam to the center of the record mark string (track) are called tracking control. Moving the object lens 25 in the focus direction and controlling the position of the object lens 25 to make the distance between the recording layer and object lens 25 identical to the focal distance of the object lens 25 are called focus control.

Though not shown in the drawing, the liquid crystal element 26 is given a predetermined electrode pattern to be able to change a refractive index according to an applied voltage, and provides a predetermined thickness or refractive index when a predetermined voltage is applied from the liquid crystal driving circuit 7. The pattern given to the liquid crystal element 26 is substantially a concentric circle about the intersection of radial and tangential directions, as shown magnified in FIGS. 1A and 1B, and used to correct spherical aberration, or the influence of uneven thickness of a protection layer of an optical disc D, by an optical beam passing through the area A and the next area B defined most close to the center. By dividing an optical beam passing through the area C outside the area B into two with respect to the tangential direction orthogonal to the radial direction, a comatic aberration component or the influence of disc tilt of an optical disc D can be corrected.

A reflected beam from the recording surface of the optical disc D is captured by the object lens 25, and converted to a beam having a substantially parallel cross section, and returned to the wavefront dividing element (HOE) 24.

The reflected beam returned to the wavefront dividing element 24 is given a predetermined diffraction characteristic in its components used as a focus error signal (FE) for the focus control, a track error signal (TE) for the tracking control, and a RF signal, according to the pattern given to the wavefront dividing element 24. The reflected beam passing through the wavefront dividing element 24 is given a phase difference by its thickness, and the direction of polarization plane is rotated by 90°.

The reflected beam, whose direction of polarization plane is rotated 90° by the wavefront dividing element 24 and given a predetermined diffraction component, is passed through sequentially the liquid crystal element 26 and collimator lens 22, and reflected toward the photodetector (PD) 27 on the plane of polarization of the polarization beam splitter 23. The reflected beam returned to the collimator lens 22 does not become a parallel light, when the thickness of the protection layer of the optical disc D changes, or when the recording surface oscillates while the optical disc D is turned.

A current output from the photodetector 27 is converted to a voltage by a not-shown I/V amplifier, and output from a signal processor 2, as a RF (reproducing) signal, a focus error signal FE, and a track error signal TE. The RF signal is converted to a predetermined signal format by a controller 3 (or a not-shown data processor), and output to a temporary storage, an external storage, or an information display/reproducing apparatus (personal computer, monitor, etc.), through a buffer 4. An uneven thickness signal th is obtained by searching a maximum value of the RF signal or track error signal TE.

Among the output signals from the signal processor 2, the focus error signal FE and track error signal TE concerning the position of the object lens 25 are used to generate a focus control signal FC and a tracking control signal TC for correcting the position of the object lens 25. FC and TC set based on FE and TE are supplied to a not-shown focus coil and track coil through a lens driving circuit 5.

The focus error signal FE is used to set the control amount of the focus control signal FC, which moves the object lens 25 in the focus (optical axis) direction orthogonal to the surface including the recording layer of the optical disc D, so that the distance from the object lens 25 to the recording layer of the optical disc D becomes identical to the focal distance of the object lens 25.

The track error signal TE is used to set the control amount of the tracking control signal TC, which moves the object lens 25 in the (Rad) direction orthogonal to the extending direction of the track (record mark) T of the recording layer.

The uneven thickness signal th indicating the uneven thickness of the protection layer of the optical disc D is used to generate a control amount (voltage value) THC to change the thickness or diffractive index of the liquid crystal element 26, and the control amount THC set based on the signal th is applied to a not-shown electrode of the liquid crystal element through a liquid crystal driving circuit 7.

Further, a laser driving signal defined according to a signal related to the intensity of light emitted from the LD (laser Diode) 21, among the output signals from the signal processor 2, is supplied to the LD 21 through a laser driving circuit 6. On the laser driving signal, the recording data entered through the controller 3 (or a not-shown data controller), or the largeness of driving current corresponding to reproduction or erasing are sequentially superposed.

Various known methods are usable as a method of detecting a focus error, track error and uneven thickness. In particular, as a track error detection method, DPD (Differential Phase Detection) and PP (Push Pull) are supposed. However, a track pitch is narrow in a HD DVD disc, and it is necessary to consider an influence of lens shit of the object lens 25. Therefore, CPP (Compensated Push Pull, compensated track error detection method) is also used to detect a track error.

Next, explanation will be given on a method of correcting the influence of the uneven thickness of a protection layer of the optical disc D by using the liquid crystal element 26, and a method of detecting the uneven thickness of a protection layer of the optical disc D by using the liquid crystal element 26.

An optical beam L from LD 21 is passed through PBS 23 and CL 22, thereby its wavefront is converted to a parallel beam. The optical beam L is sequentially passed through the liquid crystal element 26 and wavefront dividing element 24, applied to the object lens 25 and given a predetermined convergence, and condensed at a predetermined position on the recording surface of the optical disc D, or on a record mark string or a guide groove of the recording layer.

As shown magnified in FIGS. 1A and 1B, the liquid crystal element 26 is provided with a transparent electrode in at least one of the side to receive the optical beam L (the side of the collimator lens 22) and the emergent side (the side of the object lens 25). In one (or both) of the incident and emergent sides of the transparent electrode, a plurality of divided area is formed.

When a voltage is applied to the transparent electrode in a certain divided area of the liquid crystal element 26, a phase difference corresponding to the voltage amount is generated for a specific plane of polarization of the optical beam L passing through that area. Namely, a phase difference is generated for an incident optical beam, by aligning the polarizing direction of an optical beam emitted from LD 21 with the polarizing direction to generate a phase difference in the liquid crystal element 26.

By adding a different voltage to each divided area, a different phase difference can be given to each divided area. Therefore, the liquid crystal element 26 can generate a phase change according to a divided area, or a wavefront conversion, for an optional area of the wave surface of an incident optical beam.

Namely, the wavefront of the emergent beam passing through the liquid crystal element 26 becomes the state that the wavefront of the incident optical beam is converted corresponding to the divided area of the transparent electrode. By controlling the largeness of a driving voltage applied to each electrode of the liquid crystal element 26, the amount of wavefront conversion can be controlled for each divided area of the transparent electrode.

The emergent beam L converted the wavefront by the liquid crystal element 26 is applied to the object lens 25, wavefront converted by the object lens 25 (to a convergent beam), and condensed as an optical spot having a predetermined size at a predetermined position on the recording or reproducing surfaced of the optical disc D.

A reflected divergent optical beam R reflected on the recording or reproducing surface of the optical disc D is captured by the object lens 25, wavefront converted to a substantially parallel beam, and returned to the liquid crystal element 26. By passing through the HOE (wavefront conversion element) 24, the reflected beam R is of course given a predetermined diffraction pattern matching the arrangement of the detection areas (cells) of the photodetector 27. The reflected beam R is also given a predetermined phase difference by the polarization beam splitter 23, to be able to be reflected to the photodetector 27.

The reflected beam R returned to the liquid crystal element 26 is subjected to wavefront conversion reverse to that given by the liquid crystal element 26 when advancing from LD 21 to the optical disc D.

In this time, if the thickness of the protection layer of the optical disc D is uneven, or if the recording surface of the optical disc D oscillates when the optical disc D is turned, the reflected beam R emitted from the liquid crystal element 26 is returned to the collimator lens 22 as a non-parallel beam including a comatic aberration component caused by the influence of the uneven thickness or disc tilt.

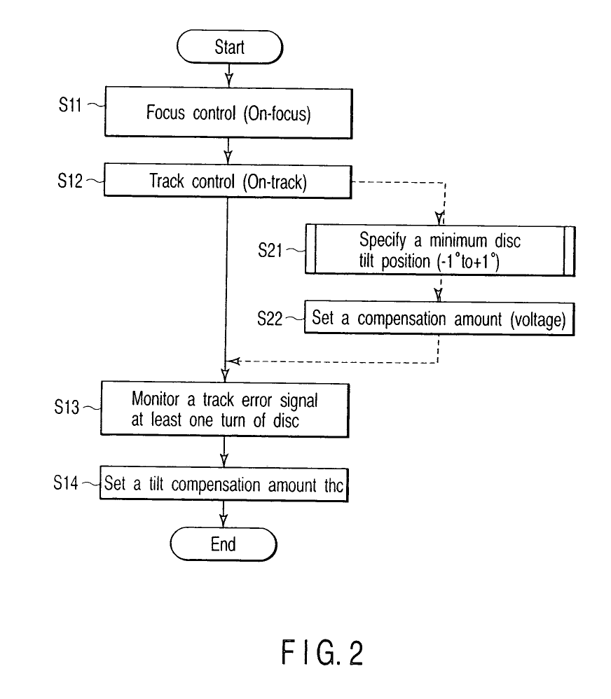

The reflected beam R returned to the collimator lens 22 is reflected to the photodetector 27 by the polarization beam splitter 23, in the state including the comatic aberration caused by the influence of the uneven thickness or disc tilt. Therefore, as previously explained in FIG. 2, the reflected beam R forms a characteristic optical spot-shaped image, including the uneven thickness or comatic aberration component, on the light-receiving surface (detection cell) of the photodetector 27.

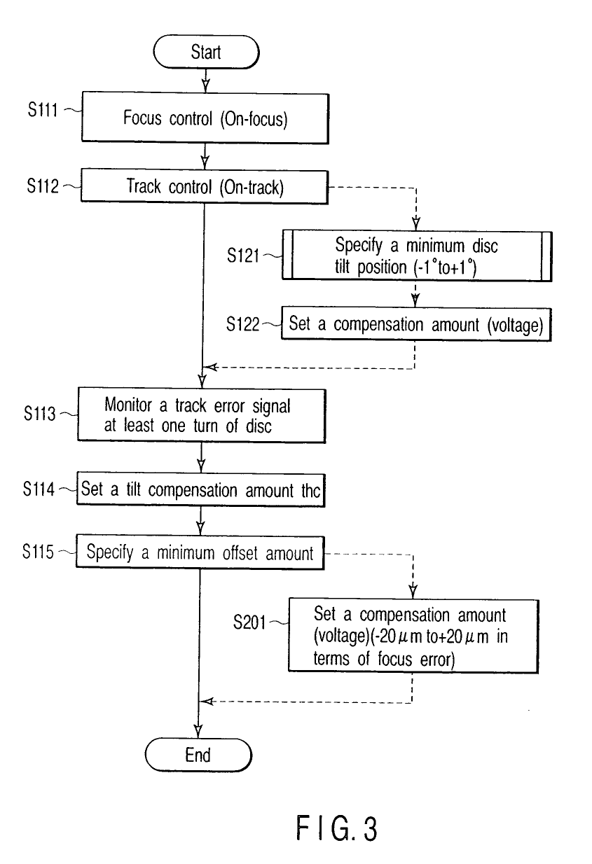

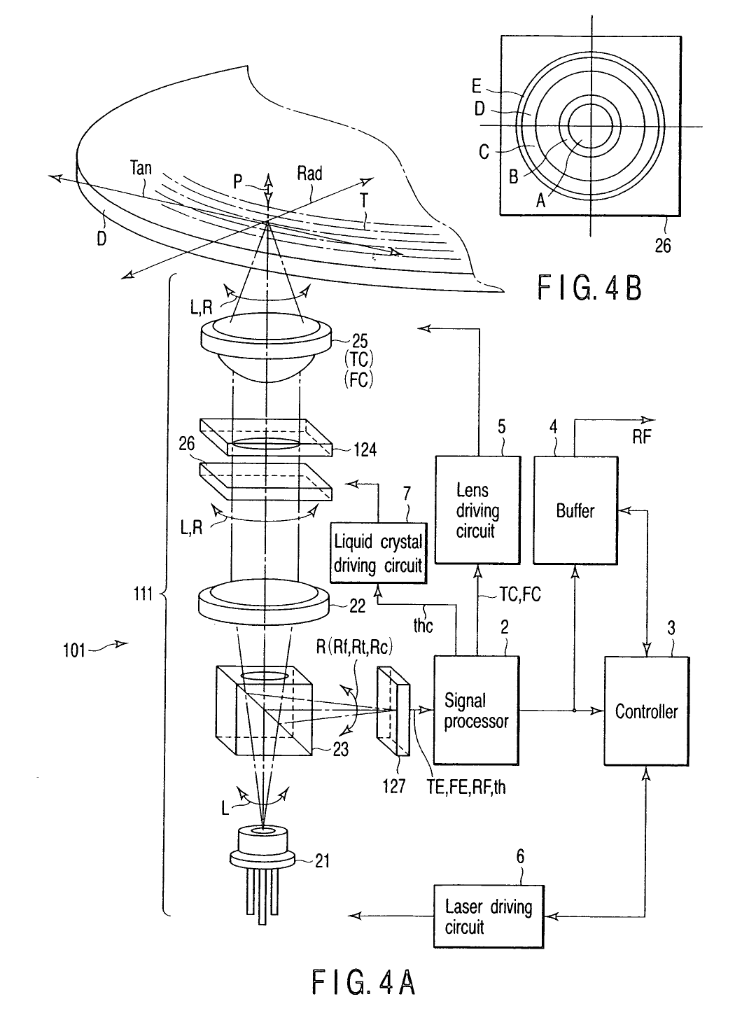

Next, an explanation will be given on the principle that the liquid crystal element 26 detects comatic aberration or oscillation on the recording surface when the optical disc D is turned, or detects an uneven thickness of a protection layer to protect a recording layer at an optional position on the optical disc D, according to the flowchart shown in FIG. 3.

First, control the object lens 25 to on-focus at an optional position in the object lens 25 and on the recording layer of the recording surface of the optical disc D, by an optical beam L from the laser diode (LD) 21 (focus control, S11).

Then, control the on-focus object lens 25 to on-track (tracking control, S12). Since the track error signal TE receives the influence of disc tilt, perform the tracking control at a position where the track error signal TE is maximum.

Therefore, in the tracking control, change the voltage and polarity applied to the electrode of the liquid crystal element 26, and specify a position where the disc tilt is minimum (S21). Namely, while monitoring the largeness of the track error signal TE, apply voltages to make a disc tilt compensation amount by the liquid crystal element 26 equivalent to −1° and +1°, sequentially to the liquid crystal element 26, and obtain a voltage (compensation amount) to make the track error signal TE is maximum (S22). In this step, the uneven thickness of the protection layer and disc tilt of the optical disc D are temporarily compensated.

Thereafter, set the track error signal TE in the state that the voltage applied to the liquid crystal element 26 is fixed to the value (voltage) obtained in step S22 (the operations up to this may be called step S12).

Then, continue monitoring the track error signal TE by turning the optical disc D by at least one turn at a predetermined speed (S13).

If the largeness of the track error signal TE fluctuates in step S13, the fluctuation reflects the largeness and distribution of a disc tilt of the optical disc D. Thus, set the tilt correction amount THC not to fluctuate the largeness of the track error signal TE. Thereafter, tilt correction will be executed (S14).

In step S13, as for an optical disc with no disc tilt, there is no wavefront change before and after incidence to the liquid crystal element 26, as a result of detection. When recording or reproducing in/from an optical disc with a disc tilt in the “+” (or “−”) side, the detected reflected beam R is applied as a non-parallel beam to the collimator lens 22, and a predetermined voltage is applied, so that the reflected beam R returned to the collimator lens 22 is converted to a parallel beam by the liquid crystal driving circuit 7. Namely, if a reflected laser beam advancing from the liquid crystal element 26 to the collimator lens 22 is a diffuse light for example when a disc tilt is “+”, a voltage of a value to cause a displacement (change) of the liquid crystal element 26 in a direction of increasing a refractive index is applied to the liquid crystal element 26. If a reflected laser beam advancing from the liquid crystal element 26 to the collimator lens 22 is a convergent light when a disc tilt is “−”, a voltage of a value to cause a displacement (change) of the liquid crystal element 26 in a direction of decreasing a refractive index is applied to the liquid crystal element 26.

By obtaining the above-mentioned tilt amount at several positions in the radial direction of the optical disc D, the influence of a disc tilt of the optical disc D can be more stably eliminated (corrected). If LD which emits an optical beam with a waveform (785 nm or 655 nm) suitable for CD or DVD is integrally or independently provided, it is possible to increase the reproduction stability (compatibility) by obtaining a disc tilt amount for each optical beam, when an optical disc apparatus is manufactured as an apparatus applicable to optical discs of different standards.

The sensitivity can be increased by setting the compensation amount of a returning path in the liquid crystal element 26 reversely, positive or negative, to the compensation amount in an advancing path. For example, the refractive index can be changed in an advancing path and a returning path, by providing an electrode on both sides of the liquid crystal element 26, and give one side electrode a voltage to act only in a returning path, and the other side electrode a voltage to act only in a returning path.

FIG. 3 shows an example of eliminating the influence of an uneven thickness on an optical disc with an uneven thickness of a protection layer to protect a recording layer of an optical disc, according to the flowchart of FIG. 2, in the state that the influence of a disc tilt is eliminated. As for correction of uneven thickness, it is assumed that the relationship between a periphery and tilt of an optical disc has been previously set to be able to eliminate the influence of a disc tilt, as shown in FIG. 2.

First, control the object lens 25 to on-focus at an optional position in the object lens 25 and on the recording layer of the recording surface of the optical disc D, by an optical beam L from the laser diode (LD) 21 (focus control, S111).

Then, control the on-focus object lens 25 to on-track (tracking control, S112). Since the track error signal TE receives the influence of disc tilt, perform the tracking control at a position where the track error signal TE is maximum.

Therefore, in the tracking control, change the voltage and polarity applied to the electrode of the liquid crystal element 26, and specify a position where the disc tilt is minimum (S121). Namely, while monitoring the largeness of the track error signal TE, apply voltages to make a disc tilt compensation amount by the liquid crystal element 26 equivalent to −1° and +1°, sequentially to the liquid crystal element 26, and obtain a voltage (compensation amount) to make the track error signal TE is maximum (S122). In this step, the uneven thickness of the protection layer and disc tilt of the optical disc D are temporarily compensated.

Thereafter, set the track error signal TE in the state that the voltage applied to the liquid crystal element 26 is fixed to the value (voltage) obtained in step S122 (the operations up to this are included in step S112).

Then, continue monitoring the track error signal TE by turning the optical disc D by at least one turn at a predetermined speed (S113). If the largeness of the track error signal TE fluctuates in step S113, the fluctuation reflects the largess and distribution of a disc tilt of the optical disc D. Thus, set the tilt correction amount THC not to fluctuate the largess of the track error signal TE. Thereafter, tilt correction will be executed (S114).

The amount of compensation of the liquid crystal element 26 (the voltage applied to the liquid crystal element 26) is sequentially changed according to a predetermined routine, to make an offset amount minimum when detecting a focus error according to a change in a tilt during one turn of an optical disc (115).

Namely, a voltage applied to the liquid crystal element 26 to make the amplitude of RF signal maximum is obtained (S201). For example, while monitoring the track error signal or maximum RF amplitude, change the thickness or refractive index of the liquid crystal element 26 in a range corresponding to [−20 μm] to [+20 μm] in terms of focus error amount (control the applied voltage). In this time, the compensation amount (applied voltage) to make the RF amplitude maximum becomes an optimum amount of aberration correction.

In step S115, as for an optical disc not having an uneven thickness of a protection layer, there is no wavefront change before and after incidence to the liquid crystal element 26, as a result of detection. When recording or reproducing in/from an optical disc having an uneven thickness of a protection layer in the “+” (or “−”) side, the detected reflected beam R is applied as a non-parallel beam to the collimator lens 22, and a predetermined voltage is applied, so that the reflected beam R returned to the collimator lens 22 is converted to a parallel beam by the liquid crystal driving circuit 7. Namely, if a reflected laser beam advancing from the liquid crystal element 26 to the collimator lens 22 is a diffuse light for example when the uneven thickness of a protection layer is “+”, a voltage of a value to cause a displacement (change) of the liquid crystal element 26 in a direction of increasing a refractive index is applied to the liquid crystal element 26. If a reflected laser beam advancing from the liquid crystal element 26 to the collimator lens 22 is a convergent light when the uneven thickness of a protection layer is “−”, a voltage of a value to cause a displacement (change) of the liquid crystal element 26 in a direction of decreasing a refractive index is applied to the liquid crystal element 26.

By obtaining the above-mentioned uneven thickness amount at several positions in the radial direction of the optical disc D, the influence of a partial uneven thickness of a protection layer of the optical disc D can be more stably eliminated (corrected). If LD which emits an optical beam with a waveform (785 nm or 655 nm) suitable for CD or DVD is integrally or independently provided, it is possible to increase the reproduction stability (compatibility) by obtaining an uneven thickness amount for each optical beam, when an optical disc apparatus is manufactured as an apparatus applicable to optical discs of different standards. The sensitivity can be increased by setting the LCD compensation amount of a returning path reversely, positive or negative, to the LCD compensation amount in an advancing path. For example, as shown before, the refractive index can be changed in an advancing path and a returning path, by providing an electrode on both sides of the liquid crystal element 26, and give one side electrode a voltage to act only in a returning path, and the other side electrode a voltage to act only in a returning path.

As described above, according to the invention, it is possible to detect parallelism of a reflected beam passing through a liquid crystal element variable in the thickness or refractive index put between a light source and an object lens, by a photodetector used for detecting a signal, and to detect and correct a disc tilt and uneven thickness of a protection layer of an optical disc so that the detected reflected beam becomes substantially a parallel light, by controlling the thickness or refractive index of the liquid crystal element, without adding an exclusive detection system.

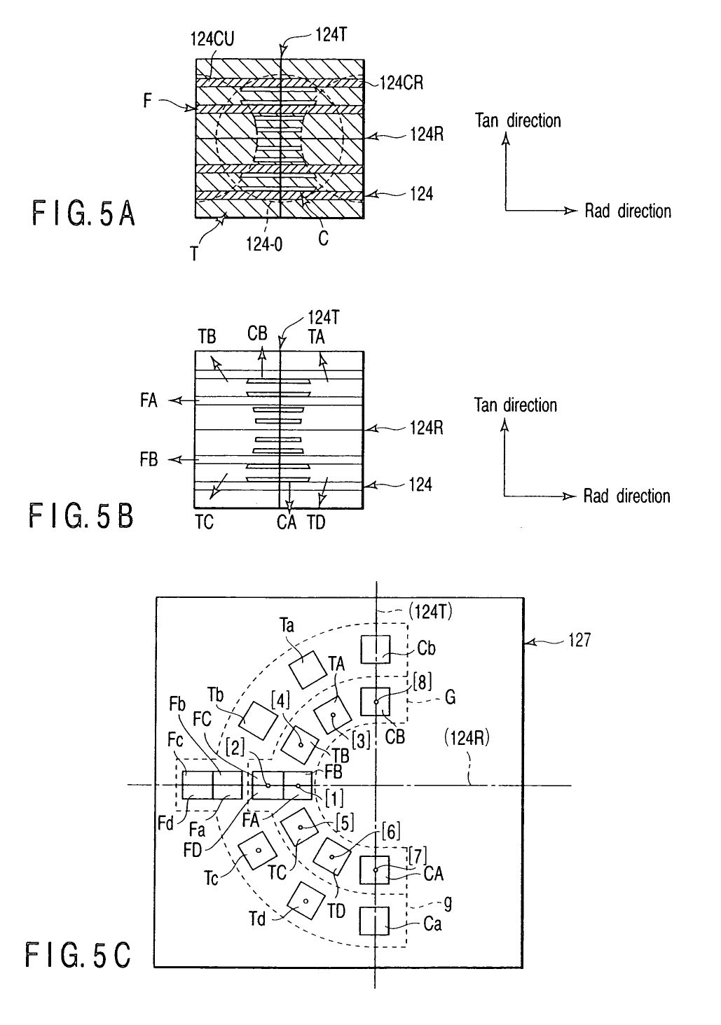

FIGS. 5A and 5B show an example of increasing the gain of RF (reproducing) signal (including a track error signal or a focus error signal), by giving a specific dividing pattern to a wavefront dividing element (HOE), in the optical head unit shown in FIGS. 1A and 1B. The same elements (components) explained in FIGS. 1A and 1B are given the same reference numerals, and will not be explained in detail.

In an optical head unit 101 shown in FIGS. 5A and 5B, an optical beam L from a light source (laser diode) 21 is paralleled by a collimator lens 22, transmitted sequentially through a liquid crystal element 26 and a wavefront dividing element (HOE) 124, and condensed on a recording layer of a recording surface of an optical disc D as an optical spot of a predetermined size by an object lens 25.

The reflected beam R from the recording layer of the recording surface of the optical disc D is captured by the object lens 25, paralleled, and returned to the wavefront dividing element 124. As shown partially magnified in FIGS. 5A and 5B, the wavefront dividing element 124 has a wavefront dividing pattern similar to the known knife-edge method, and gives a predetermined dividing pattern to the reflected beam R. Of course, the wavefront dividing element 124 has a function as a λ/4 plate to turn the phase difference between the reflected beam R and optical beam L (advancing to an optical disc), that is, the direction of polarization of wavefront, by 90°.

When the optical disc D has a disc tilt or uneven thickness of a protection layer, the reflected beam R is returned to the liquid crystal element 26, as a non-parallel light, and guided to the collimator lens 22.

The reflected laser beam R passing through the collimator lens 22 is reflected by the polarization beam splitter 23 toward a photodetector 127 given a predetermined light-receiving pattern.

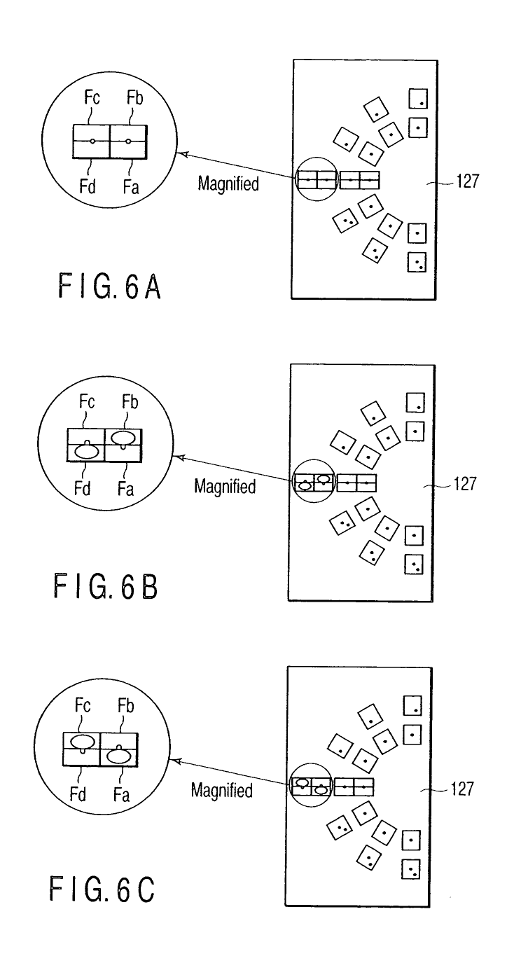

Assuming that the wavefront dividing element (HOE) 124 is given a polarization pattern having the similar characteristic to the known knife-edge method, as shown in FIGS. 6A to 6C, the photodetector 127 is formed by adjoining two light-receiving cells so that a division line 124R of HOE 124 can be regarded as a partition line in the state that the dividing line 124R is being projected. A component diffracted by an area FA (reflected beam Rf) and component diffracted by an area FB (reflected beam Rf), for example, are applied to the light-receiving cells.

The patterns of four light-receiving cells of the photodetector 127 corresponding to the optical beam Rt for a track error are defined at four positions, not to overlap the cell prepared for detection of a focus error, so that the components divided (diffracted) by the four areas of the HOE 124 can be independently detected. The positions of the light-receiving cells and the distance from the center as a point of intersection of the division lines 124R and 124T of HOE 124, for example, in the state that the point of intersection of the division lines 124R and 124T of HOE 124 is projected, are defined according to the pattern of HOE 124, as described before.

The patterns of two light-receiving cells of the photodetector 127 corresponding to the optical beam Rc for a track error correction signal are defined at two positions (at least), not to overlap the cells prepared for detection of a focus error and track error, so that the components divided (diffracted) by the division line 124T of HOE 124 can be independently detected. The positions of the light-receiving cells and the distance from the center as a point of intersection of the division lines 124R and 124T of HOE 124, for example, in the state that the point of intersection of the division lines 124R and 124T of HOE 124 is projected, are defined according to the pattern of HOE 124, as described before.

Among the reflected beams, the optical beam for the RF signal is diffracted by an optional (or all) diffraction pattern of HOE 124, and converted to a signal by a predetermined corresponding light-receiving cell. Therefore, the RF signal can be obtained by adding the output of an optional light-receiving cell of the photodetector 127.

A polarization pattern given to the wavefront dividing element 124 shown in FIG. 5A and FIG. 5B can be, in detail, can divide the optical beam reflected on the recording layer of the optical disc D into two optical beams Rf for a focus error, four optical beams Rt for a track error, and two optical beams Rc for a track error correction signal, and diffract them in a predetermined direction.

The HOE 124 is divided into two or four by cross-hair division lines (124T and 124R) crossed at a portion substantially identical to the center of the cross section of the optical spot of the reflected beam R.

More specifically, the coarsely divided area F given to the HOE 124 is a pattern defined parallel to the division line 124R. The coarsely divided area F is composed of the finely divided areas FA and FB consisting of belt-like slender areas arranged at a predetermined interval, and divided into two areas FA and FB taking the division line 124R as a boundary.

The coarsely divided area T given to the HOE 124 is a pattern defined by areas except the coarsely divided areas C and F. The coarsely divided area T is divided into four areas TA, TB, TC and TD taking the division lines 124T and 124R as a boundary.

Among the coarsely divided areas, the area F is used to generate a focus error signal (FE), the area T is used to generate track error signals TE (DPD) and TE (PP), and the area C is used to generate a track error correction signal TE (CPP) to eliminate an influence of offset in the system including the influence of the offset of the object lens 25.

The arc-shaped division lines CR and CL are the boundary of the coarsely divided areas C and T, assuming detection of a reflected beam from an optical disc with a fixed pitch defined by the standard of that disc, or two or more optional optical disks with different pitches of a track or a recording mark string T. Assuming that a spot of a reflected beam reaching the HOE 124 is 124-0, either a diffracted light (±1^{st}) of an optical beam from a disc having a wide track pitch Tp or a diffracted light (±1^{st}) of an optical beam from a disc having a narrow track pitch Tp includes an area overlapping the spot 124-0.

In FIG. 5C, the group 1 (G, displayed in uppercase) and group 2 (g, displayed in lowercase) divided by a broken line are correlated when detecting a reflected laser beam from optional two optical discs with two pitches, if the pitches of a track or a record mark string T peculiar to each optical disc are different. The pitch of a track or a recording mark string T is 0.68 μm in a current DVD standard optical disc, and 0.4 μm in a HD DVD standard optical disc.

More specifically, a diffraction pattern given to the wavefront dividing element (HOE) 124 is divided as shown in FIG. 6A, and the reflected beams Rf, Rt and Rc are deflected in the direction shown in FIG. 5B. FIG. 5C shows an example of arrangement of light-receiving cells of a corresponding photodetector 127.

Therefore, a reflected beam is actually divided in a wavefront into eight in total.

Component by the area 124-FA (optical spot) [1],

Component by the area 124-FB (optical spot) [2],

Component by the area 124-TA (optical spot) [3],

Component by the area 124-TB (optical spot) [4],

Component by the area 124-TC (optical spot) [5],

Component by the area 124-TD (optical spot) [6],

Component by the area 124-CA (optical spot) [7], and

Component by the area 124-CB (optical spot) [8].

The optical spots [1] and [2] require two light-receiving cells for one component when using the knife-edge method as a focus detection method, and the number of light-receiving cells of a photodetector becomes ten.

The relation between the areas divided by the HOE 124 and the light-receiving areas (light-receiving cells) of the photodetector 127 is as follows.

Component (optical spot) divided by the HOE area 124-FA (optical spot) [1]

→ Photodetector areas [FA] and [FB],

Component (optical spot) divided by the HOE area 124-FB (optical spot) [2]

→ Photodetector areas [FC] and [FD],

Component (optical spot) divided by the HOE area 124-TA (optical spot) [3]

→ Photodetector area 127-[TA],

Component (optical spot) divided by the HOE area 124-TB (optical spot) [4]

→ Photodetector area 127-[TB],

Component (optical spot) divided by the HOE area 124-TC (optical spot) [5]

→ Photodetector area 127-[TC],

Component (optical spot) divided by the HOE area 124-TD (optical spot) [6]

→ Photodetector area 127-[TD],

Component (optical spot) divided by the HOE area 124-CA (optical spot) [7]

→ Photodetector area 127-[CA], and

Component (optical spot) divided by the HOE area 124-CB (optical spot) [8]

→ Photodetector area 127-[CB].

From FIG. 5C, assuming that the output from each light-receiving cell of the photodetector 127 is p[**] (**: an identifier of a corresponding light-receiving cell), the focus error signal (FE) can be obtained by any one of the equations
FE=p[FA]−p[FB]
or
FE=p[FB]−p[FA]
or
FE=p[FC]−p[FD]
or
FE=p[FD]−p[FC].

The outputs to make a pair may be added, of course.

Likewise, from FIG. 6C, in the DPD method, the track error signal (TE) can be obtained by the equation
TE(DPD)=Ph(p[TA]+p[TC])−ph(p[TB]+p[TD])
or
TE(DPD)=Ph(p[TB]+p[TD]−ph(p[TA]+p[TC]).

From FIG. 6C, in the PP method, the track error signal (TE) is obtained by the equation
TE(PP)=(p[TA]+p[TD]−(p[TB]+p[TC]
or
TE(PP)=(p[TB]+p[TC]−(p[TA]+p[TD].

The compensated push pull (CPP) when the lens shift of an object lens is included is obtained by the equation
TE(CPP)=TE(PP)−K*(p[CA]−p[CB])
or
TE(CPP)=TE(PP)−K*(p[CB]−p[CA])

where, K is a compensation coefficient obtainable from the facts, such as, LD used and coarsely divided areas T and C, and may be either positive or negative.

FIGS. 6A to 6C explain the relation of the degree of uneven thickness of a protection layer or disc tile of the optical disc D to an image forming pattern on each cell when a light-receiving cell (photodetector 127) arranged as shown in FIG. 5C receives a reflected beam R passing through the liquid crystal element 26 and the wavefront dividing element 124 given a polarization (diffraction) pattern shown in FIG. 5A.

As shown in FIG. 6A, when the uneven thickness th of the protection layer of the optical disc D is th=0, or a reference value, each pattern to be formed in the 4-divided areas FA-FD of the photodetector 127 is on the intermediate point (on the division line) between the areas FA and FB. Therefore, the total output can be set to 0 by predetermined addition or subtraction of the outputs of four detection cells.

As shown in FIG. 6B, when the uneven thickness th of the protection layer of the optical disc D is th>0, thicker than a reference value, each pattern to be formed in the 4-divided areas FA-FD of the photodetector 127 projects to the areas FA and FC. Therefore, the total output can be set to other than 0 by predetermined addition or subtraction of the outputs of four detection cells.

As shown in FIG. 6C, when the uneven thickness th of the protection layer of the optical disc D is th<0, thinner than a reference value, each pattern to be formed in the 4-divided areas FA-FD of the photodetector 127 projects to the areas FA and FC (on the cross side when considering the areas FA and FC as a reference). Therefore, the total output can be set to other than 0 by predetermined addition or subtraction of the outputs of four detection cells.

The routine for detection and correction of an uneven thickness of a protection layer to protect a recording layer of an optical disc D, and the routine for detection and correction of a disc tilt (comatic aberration) are substantially the same as the flowchart shown in FIG. 2 and FIG. 3, and detailed explanation will be omitted.

As explained hereinbefore, according to the invention, the amount of spherical aberration corresponding to an error in the thickness of a protection layer of a recording medium (optical disc) and the amount of comatic aberration corresponding to a disc tilt can be detected by a liquid crystal element for aberration control, and the correction amount can be controlled by the same liquid crystal element. Therefore, an optical head unit can be made compact. Further, by using this optical head unit, 1) the light use efficiency is increased, 2) a stray light is decreased, and 3) the number of light-receiving cells is decreased. Therefore, a reproducing signal is stabilized, and the reliability as an optical disc apparatus is increased. An optical head unit is made compact. Further, as the light use efficiency of laser beam is increased, an output signal is hardly influenced by a noise.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical head unit comprising:
an object lens which captures an optical beam reflected on a recording surface of a recording medium;
a phase control member which transmits an optical beam captured by the object lens in a state including the influence of at least one of a spherical aberration that is a change in the thickness of a protection layer to protect a recording surface of a recording medium and a comatic aberration that is an influence of oscillation of a recording surface of a recording medium during rotation, and associates with a change in parallelism of the optical beam according to the degree of a change in the thickness of the protection layer or oscillation of the recording surface during rotation; and
a photodetector which detects an optical beam passing through the phase control member by optional number of detection cells, and obtains an output to set the amount of control of the phase control member.

2. The optical head unit according to claim 1, wherein the phase control member is a liquid crystal element whose refractive index is partially changed according to a voltage to be applied, and changes parallelism of the optical beam according to the degree of a change in the thickness of the protection layer or oscillation of the recording surface during rotation.

3. The optical head unit according to claim 1, wherein the phase control member is a liquid crystal element whose refractive index is partially changed according to a voltage to be applied, and changes parallelism of the optical beam according to a voltage to be applied.

4. The optical head unit according to claim 2, wherein the phase control member is a liquid crystal element whose refractive index is partially changed according to a voltage to be applied, and changes parallelism of the optical beam according to a voltage to be applied.

5. A disc tilt control method using an optical head unit comprising an object lens which captures an optical beam reflected on a recording surface of a recording medium; a phase control member which transmits an optical beam captured by the object lens in a state including an influence of at least one of a spherical aberration that is a change in the thickness of a protection layer to protect a recording surface of a recording medium and a comatic aberration that is an influence of oscillation of a recording surface of a recording medium during rotation, and associates with a change in parallelism of the optical beam according to the degree of a change in the thickness of the protection layer or oscillation of the recording surface during rotation; and a photodetector which detects an optical beam passing through the phase control member by optional number of detection cells, and obtains an output to set the amount of control of the phase control member, the disc tilt control method comprising:
controlling an object lens to on-focus at an optional position on a recording layer of a recording surface of a recording medium;
controlling an object lens to on-track at a position where a track error signal becomes maximum; and
setting a tilt correction amount not to fluctuate the size of a track error signal, by turning a recording medium by at least one turn.

6. The disc tilt control method according to claim 5, where a position where a track error signal becomes maximum is specified by applying voltages to make a disc tilt compensation amount provided by a phase control member equivalent to −1° and +1°, sequentially to a phase control member, while monitoring a track error signal.

7. An uneven thickness correction method using an optical head unit having an object lens which captures an optical beam reflected on a recording surface of a recording medium; a phase control member which transmits an optical beam captured by the object lens in a state including an influence of at least one of a spherical aberration that is a change in the thickness of a protection layer to protect a recording surface of a recording medium and a comatic aberration that is an influence of oscillation of a recording surface of a recording medium during rotation, and associates with a change in parallelism of the optical beam according to the degree of a change in the thickness of the protection layer or oscillation of the recording surface; and a photodetector which detects an optical beam passing through the phase control member by optional number of detection cells, and obtains an output to set the amount of control of the phase control member, the uneven thickness correction method comprising:
controlling an object lens to on-focus at an optional position on a recording layer of a recording surface of a recording medium;
controlling an object lens to on-track at a position where a track error signal becomes maximum; and
setting a voltage applied to a liquid crystal element to make an offset amount minimum when detecting a focus error in response to a change in a tilt while a recording medium is turned by at least one turn.

8. The uneven thickness correction method according to claim 7, wherein a voltage applied to a liquid crystal element is a compensation amount to make an output corresponding a reproducing signal of a photodetector maximum, when changing the thickness or refractive index of a phase control member in a range equivalent to −20 μm-+20 μm in terms of a focus error amount, while monitoring a track error signal.

9. An optical disc apparatus comprising:
an optical head unit including an object lens which captures an optical beam reflected on a recording surface of a recording medium; a phase control member which transmits an optical beam captured by the object lens in a state including an influence of at least one of a spherical aberration that is a thickness change in a protection layer to protect a recording surface of a recording medium and a comatic aberration that is an influence of oscillation of a recording surface of a recording medium during rotation, and associates with a change in parallelism of the optical beam according to the degree of a change in the thickness of the protection layer or oscillation of the recording surface; and a photodetector which detects an optical beam passing through the phase control member by optional number of detection cells, and obtains an output to set the amount of control of the phase control member; and
a signal processing circuit which obtains a reproducing output corresponding to information recorded on a recording surface of a recording medium, from a signal detected by the photodetector.
